(19) United States
(12) Patent Application Publication
(10) Pub. No.: US 2026/0192189 A1
(43) Pub. Date: Jul. 9, 2026

(54) Virtual Reality Surfing Controller And Game

(71) Applicant: Wave Ki, Huntington Beach, CA (US)

(72) Inventor: Bradley Gerlach, Huntington Beach, CA (US)

(21) Appl. No.: 19/373,354

(22) Filed: Oct. 29, 2025

Related U.S. Application Data
(60) Provisional application No. 63/713,489, filed on Oct. 29, 2024.

(51) Int. Cl. A63F 13/245; A63F 13/218; A63F 13/235; A63F 13/285

(52) U.S. Cl. CPC A63F 13/245; A63F 13/218; A63F 13/235; A63F 13/285; A63F 2300/8041; A63F 2300/8082

(57) ABSTRACT

A mat has pressure sensors that electronically report weight distribution of a user while the user is performing body motions indicative of an activity in surfing or other sport. Information from the pressure sensors is processed, and compared with corresponding data of other users, or the same user at a different time. Comparison data can be gamified.

### PRIORITY CLAIM

This application claims priority to US provisional application serial no. 63/713489 filed Oct. 29, 2024.

### BACKGROUND

The background description includes information that may be useful in understanding the present invention. It is not an admission that any of the information provided herein is prior art or relevant to the presently claimed invention, or that any publication specifically or implicitly referenced is prior art.

Surfing is a hard sport to learn. Video games can simulate many disciplines, and with virtual reality increasingly so. However, a normal video game controller does not properly simulate the surfing environment so current systems do not help train players to actually learn to surf. Wave pools are a good training aid, but they require a large space to operate and are expensive to access frequently.

The current format for Surf Competitions is boring. The current format for the WSL NSSA WSA ISA Surfing competitions are all the same, they either have 4 or 3 or 2 man heats. With a heat times of 15 to 30 mins. They calculate each competitors best two waves for the total heat score. The highest two scores win based on two wave total and then the winners of that heat advance onto the next round to meet their next opponents until they narrow it down to a winner. This is a tedious long drawn out completion that goes normally 4-8 hours per day and some even longer and they go on for days depending on how many competitors entered.

The tedious nature of the current format bores the viewers and even many surf enthusiasts find it difficult to apply their attention to the contests due to this.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need for a system that simulates the sport of surfing and a fun competition that attracts new viewers to the sport.

### DETAILED DESCRIPTION

It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The systems and methods of the inventive subject matter include a surfing game presented via virtual reality that uses a surf mat controller having sensors upon which a surfboard is laid.

The surf mat controller is made of a foam having a density that provides a realistic amount of support and resistance when a surfboard is placed on top. The surf mat controller can include a shaped section that is dimensioned to receive a portion of a surfboard such that the board is firmly held by the surf mat controller without slipping off during use.

The surf mat controller includes a plurality of sensors that detect pressure points/weight at different points of the controller. This translates the balance, stance and weight shifts detected to the game in real time, which is reflected then as inputs in the game.

The use of the player's actual surfboard helps the player get accustomed to moving on their own board - include the texture of the board on their feet, the amount of slip experienced, and the dimensions of their board.

In embodiments of the inventive subject matter, the surf mat controller can include one or more vibration mechanisms that can cause the surfboard to vibrate, further enhancing the realism.

In embodiments of the inventive subject matter, the surf mat controller can include one or more actuation mechanisms that can change the surface shape of the controller, and thus change the angle and placement of the board on the controller, simulating how the surface under a surfboard can change when on the water and riding a wave.

The surf mat controller can be connected to a computer, gaming console or VR headset via a wired or wireless connection. When coupled with a VR headset, a wireless connection may be preferred to reduce the chances that the player will become tangled with a wired setup.

The game can be presented via a virtual reality (“VR”) headset, that can further track the user's movements and present the game in a realistic, first-person perspective. The handheld controller(s) of the VR headset can be used to further communicate the body position of the user to the game, as well as actions such as paddling with the hands.

The following is an example of a surfing competition that can be executed in the game, and can also be implemented “in real life.” This competition improves over existing competitions by removing the tedium of the long competitions of the past. This can be called the Wave 4 Wave format:

The winner of the match advances in the competition/tournament.

Games within a Match: A match can comprise best of 3 or best of 5 or best of 7 games. The games can involve 2 players/surfers in a one versus one competition. The best wave wins each game.

Each game has a limited time frame (for example, 5 min) and starts with a ride. The surfers start by holding a rail. The moment one of the surfers hands leave the rails regulation time starts counting down. Both surfers use the same clock.

In embodiments, each player can get 3, 5 or 7 timeouts depending on number of games in match. The timeouts can be for a minute or other set time. The match play times and timeouts can be set by the organizing body before the competition.

The surfer who calls timeout can take off on a wave during the timeout but the moment the hands leave the rails the regulation clock starts again and they forfeit the rest of the timeout. Alternatively that time is saved and used for the end of the match (such as extra time in soccer). Surfers won't know exactly how much extra time to play with, which can add drama that is fun to watch.

A surfer/player can use timeouts whenever they choose. All in first heat, stagger them or save for last heat.

The other surfer (the opponent) can surf and be scored during time out. The Opponent might be winning so prob not going to take a wave but it is allowed. The purpose would be to better their own ride. The timeouts are not used to keep a surfer off a wave.

Regulation clock resumes when surfer who used the time out stands or timeout is done.

Surfers stay in the water until match is over.

In embodiments, no coaches are allowed.

If waves are consequential, a surfer can call timeout prior to a ride if it's within 3 seconds of the ride with a signal (e.g., the raise of an arm). In embodiments, a timeout could be allowed after the ride. For example: if a surfer eats it and comes up to call time out it could be too late. Basically, that surfer will want to stop the clock to give themselves another chance.

In embodiments, coaches can be permitted. Normally, with a bigger venue that can hold more people a surfers coach would call timeout. He would be deemed an official coach of the surfer.

Flip of coin winner gets a choice of priority in first game of match or priority for tie breaker match.

Best wave wins each game. Majority of games won in match wins the match and moves on.

In embodiments, each player is given a color. (e.g., black or white). The best wave will show the color of the better wave from the competition site, boat, or other display. In embodiments, the winner can be communicated via a radio from the water to the shore (e.g., a radio to water patrol).

The time can be signaled by flags. For example: Green Flag-regulation time; Red Flag—time is over; Yellow Flag—Time Out. In embodiments, additional flags can be used. For example, a checkered flag can denote a 1 min warning.

In embodiments, a referee or the hosting body can also call time outs for various reasons. For example, if only one wave comes ref can call a time out. The referee or organization can also pause competition for natural causes, crazy lulls, sharks, severe weather, injury, broadcast considerations or other factors.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A surfing simulation system comprising:
a surf mat controller comprising a plurality of pressure sensors distributed throughout the controller, the surf mat controller dimensioned to receive at least a portion of a surfboard;
a computing device communicatively coupled with the surf mat controller, the computing device programmed to execute a surfing game that is controlled via the surf mat controller; and
a display coupled with at least one of the computing device and the surf mat controller, the display configured to display the surfing game to a user.

2. The system of claim 1, wherein the display is a virtual reality headset.

3. The system of claim 1, wherein a top surface of the surf mat controller is shaped to accommodate the surfboard.

4. The system of claim 1, wherein the computing device is programmed to execute a surf competition within the surfing game.

5. The system of claim 1, wherein the surf mat controller further comprises at least one actuator configured to exert a force on the surfboard.

6. The system of claim 1, wherein the surfing game is programmed to prepare the user for live surfing.

7. The system of claim 1, wherein the computing device and the display are both integral to a virtual reality headset.
